(19) United States
(12) Patent Application Publication
(10) Pub. No.: US 2016/0217461 A1
(43) Pub. Date: Jul. 28, 2016

(54) TRANSACTION UTILIZING ANONYMIZED USER DATA

(71) Applicants: Ajit Gaddam, LakesideDrive, CA (US); Gyan Prakash, Foster City, CA (US); Selim Aissi, Menlo Park, CA (US)

(72) Inventors: Ajit Gaddam, LakesideDrive, CA (US); Gyan Prakash, Foster City, CA (US); Selim Aissi, Menlo Park, CA (US)

(21) Appl. No.: 15/004,635

(22) Filed: Jan. 22, 2016

Related U.S. Application Data
(60) Provisional application No. 62/107,259, filed on Jan. 23, 2015.

(51) Int. Cl. G06Q 20/38; G06Q 20/40

(52) U.S. Cl. CPC G06Q 20/383; G06Q 20/405

(57) ABSTRACT

A user requests to utilize anonymized user data to conduct a transaction. The anonymized user data keeps the user's sensitive data private, while still allowing certain entities to perform fraud analyses. The user configures a specific combination of user data elements to be anonymized prior to or at the time of the transaction. In some embodiments, the specific combination may be associated with a location or merchant type, which can also be selected by the user. The registration of a password associated with the anonymized user data may further increase security of the transaction.

### CROSS-REFERENCES TO RELATED APPLICATIONS

This application is a non-provisional of and claims the benefit of priority to U.S. Provisional Application No. 62/107,259, filed Jan. 23, 2015, which is hereby incorporated by reference in its entirety for all purposes.

### BACKGROUND

The use of real identity information to conduct transactions is, in many instances, undesirable. Real identity information (e.g., a user's real name, address, credit card number, etc.) can be stolen and used for fraudulent purposes. In addition, some parties may legitimately hold the real identity information of a person, but may use it in a way that is inconsistent with the way that the person desires or intends. For example, a merchant may mine user data and utilize findings to market to its customers. In one well publicized case, after mining its customers' data, a merchant repeatedly sent ads for baby products to a household of one of its customers. That customer happened to be pregnant, unbeknownst to the other members of the customer's household. Also, alternative methods for conducting transactions based upon public ledgers are also becoming more popular (e.g., Bitcoin). In some instances, personal information may be transmitted to various other computers in a computer network.

Conventional methods for protecting data can include the use of encryption. However, relying on encryption alone presents a number of challenges. For example, it is difficult to distribute encryption keys to user devices, and encryption techniques require end points to be coordinated to some extent. Further, information that is encrypted may not be useable with existing systems. For example, if a 16 digit credit card number is encrypted, it is anonymized, but it may not be routable through an existing data transport network because some of the numbers in the original credit card number are used to route it to the appropriate destination. Lastly, strict encryption techniques are not flexible. For example, one person might believe that his home address constitutes sensitive information, while another person might not think that his home address constitutes sensitive information. Existing systems cannot accommodate the perceptions of what is and is not sensitive to specific users.

Embodiments of the invention address this and other problems, individually and collectively.

### BRIEF SUMMARY

Embodiments of the present invention relate to systems and methods for generating and utilizing anonymized user data that can help facilitate user privacy, while still providing sufficient information to ensure security of a transaction. These systems and methods can allow users configurable privacy options surrounding their sensitive data. For example, users can select certain user data elements that should remain private during a particular transaction.

According to one embodiment of the invention, a user device or different device associated with a user can receive anonymized user data elements corresponding to user data elements associated with an account of the user and can transmit the anonymized user data elements to a server computer. The user device can receive a request to conduct a transaction with anonymized user data associated with the account, the request including a specific combination of user data elements selected by the user. In some embodiments, the user may dynamically select the specific combination of user data elements at the time of the transaction. The user device can then generate a request to anonymize at least one user data element indicated in the specific combination.

Subsequently, the user device can receive the anonymized user data including at least one anonymized user data element associated with the at least one user data element indicated in the specific combination and can transmit the anonymized user data to an access device. In some embodiments, the access device may generate and send an authorization request message including the anonymized user data to the server computer. The user device can generate an authorization request message including some or all of the anonymized user data. In some embodiments, the user device can transmit the request to anonymize the at least one user data element to the server computer, which may generate the anonymized user data.

In some embodiments, the user data elements in the specific combination of user data elements can be associated with a location, type of resource provider, or transaction amount. In some cases, the specific combination of user data elements can further be associated with a number of transactions for which it can be utilized selected by the user.

According to one embodiment of the invention, the user device may store a binding between the anonymized user data elements and the user data elements associated with the account of the user. In some cases, the user device can generate the anonymized user data. Subsequently, the anonymized user data can be stored at the user device.

According to one embodiment of the invention, the server computer may stores bindings between the anonymized user data elements and the user data elements associated with the account of the user. In some cases, the server computer can generate the anonymized user data. Subsequently, the server computer can send the anonymized user data to the user device.

According to one embodiment of the invention, a server computer can receive, from a user device or different device associated with a user, anonymized user data elements corresponding to user data elements associated with an account of the user. The server computer can store the anonymized user data elements in association with the corresponding user data elements. The server computer may receive a request including a specific combination of user data elements selected by the user for a transaction to anonymize at least one user data element indicated in the specific combination of user data elements. Subsequently, the server computer may determine the specific combination of user data elements from the request, may retrieve anonymized user data elements associated with the at least one user data element indicated in the specific combination of user data elements, and may generate anonymized user data including the anonymized user data elements for the transaction. In some embodiments, the server computer can send the anonymized user data to the user device associated with the user, wherein the user device sends the anonymized user data to an access device.

Embodiments of the invention are further directed to a user device comprising a processor and a memory element. The memory element (e.g., computer-readable medium) can comprise code, executable by the processor, for implementing methods described herein.

Embodiments of the invention are further directed to a server computer comprising a processor and a memory element. The memory element (e.g., computer-readable medium) can comprise code, executable by the processor, for implementing methods described herein.

### BRIEF DESCRIPTION OF THE DRAWINGS

FIG. 1 shows a block diagram of an exemplary system according to embodiments of the present invention.

FIG. 2 shows a block diagram of an exemplary user device according to embodiments of the present invention.

FIG. 3 shows a block diagram of some components that may be in an exemplary processing network according to embodiments of the present invention.

FIG. 4 shows an exemplary flow diagram of a method for processing a transaction with anonymized user data according to embodiments of the present invention.

FIG. 5 shows an exemplary user interface according to embodiments of the present invention.

FIG. 6 shows an exemplary user interface according to embodiments of the present invention.

FIGS. 7A and 7B show an exemplary authorization request messages according to embodiments of the present invention.

FIG. 8 shows an exemplary block diagram of an access system.

### DETAILED DESCRIPTION

Embodiments of the invention are directed to devices, systems, and methods that allow users to select specific user data elements to anonymize during a transaction. Embodiments of the invention allow different users to express different preferences for anonymizing data, while still allowing for systems to operate as they normally would. Embodiments of the invention are thus more effective and efficient than conventional anonymizing systems.

Before discussing specific embodiments and examples, some descriptions of terms used herein are provided below.

“User data elements” may include any pieces of user data. In some cases, user data elements may be associated with an account of a user. For example, user data elements may include information about a user, such as their name, address, phone number, device information (e.g., device identifier), and network information (e.g., MAC address, Bluetooth® information). In some cases, user data elements may also include payment information associated with the user, such as an account identifier (e.g., personal account number (PAN)), account identifier expiration date, and card verification value (CVV). User data may comprise one or more user data elements.

“Anonymized user data elements” may be information that is utilized in place of user data elements. For example, the text “John Smith” entered by the user can be utilized as an anonymized user data element that replaces the name of the user. The anonymized user data elements may be associated with their corresponding user data elements for which they substitute. In some cases, the anonymized user data elements can be stored in association with their corresponding user data elements.

“Anonymized user data” may be data that includes at least one anonymized user data element. In some cases, anonymized user data may include user data elements and anonymized user data elements associated with an account of a user. In other cases, anonymized user data may include only anonymized user data elements.

An “authorization request message” may be an electronic message that requests authorization. For example, the authorization request message may be sent to a processing network (e.g., payment processing network) and/or an authorization computer (e.g., issuer) of a payment card to request authorization for a transaction. An authorization request message according to some embodiments may comply with (International Organization of Standardization) ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCW (dynamic card verification value), an expiration date, and the like. An authorization request message may also comprise “transaction information,” such as any information associated with a current transaction, such as the transaction amount, merchant identifier, merchant location, etc., as well as any other information that may be utilized in determining whether to identify and/or authorize a transaction. In some embodiments, the authorization request message may comprise anonymized user data.

An “authorization response message” may be an electronic message reply that indicates authorization status. For example, the authorization response message may be a reply to an authorization request message generated by an issuing financial institution or a processing network (e.g., payment processing network). The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the processing network) to the access device (e.g. POS equipment), associated with a resource provider computer (e.g., merchant) that indicates approval of the transaction. The code may serve as proof of authorization. As noted above, in some embodiments, a processing network may generate or forward the authorization response message to the resource provider computer (e.g., merchant computer).

A “token” may include a substitute identifier for some information. A token may be a string of numbers, letters, or any other suitable characters. For example, a payment token may include an identifier for a payment account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing processing networks (e.g., ISO 8583 financial transaction message format). In some embodiments, a token may be used in place of a PAN to initiate, authorize, settle or resolve a payment transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “resource provider” may be an entity that can provide a resource such as goods, services, information, and/or access. Examples of a resource provider include merchants, access devices, secure data access points, etc. In some cases, the resource provider may operate a physical store and utilize an access device for in-person transactions. The resource provider may also sell goods and/or services via a website, and may accept payments over the Internet.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the user.

A “server computer” may include a powerful computer or cluster of computers. For example, the server computer can be a large mainframe, a minicomputer cluster, or a group of servers functioning as a unit. In one example, the server computer may be a database server coupled to a Web server. A server computer may comprise one or more computational apparatuses and may use any of a variety of computing structures, arrangements, and compilations for servicing the requests from one or more client computers.

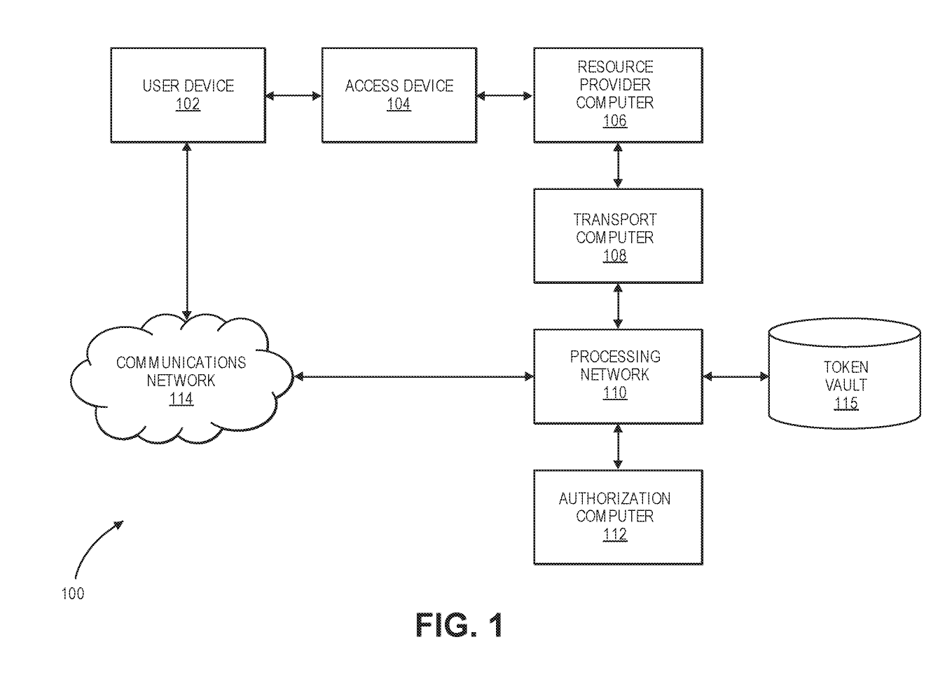

FIG. 1 shows a block diagram of a system 100 according to embodiments of the present invention. FIG. 1 includes a user device 102, an access device 104, a resource provider computer 106, a transport computer 108, a processing network 110, an authorization computer 112, a communications network 114, and a token vault 115. User device 102 may be operated by a user (e.g., consumer) conducting a transaction with a resource provider associated with resource provider computer 106. Any of the devices and computers in FIG. 1 may be in operative communication with each other through any suitable communication channel or communications network.

User device 102 may be operated by a user and may be capable of communicating information with other devices. User device 102 can include a processor, a memory, input devices, and output devices, operatively coupled to the processor. Some non-limiting examples of user device 102 may include mobile devices (e.g., cellular phones, keychain devices, personal digital assistants (PDAs), pagers, notebooks, laptops, notepads, wearable devices (e.g., smart watches, fitness bands, jewelry, etc.), automobiles with remote communication capabilities, personal computers, payment cards (e.g., smart cards, magnetic stripe cards, etc.), and the like.

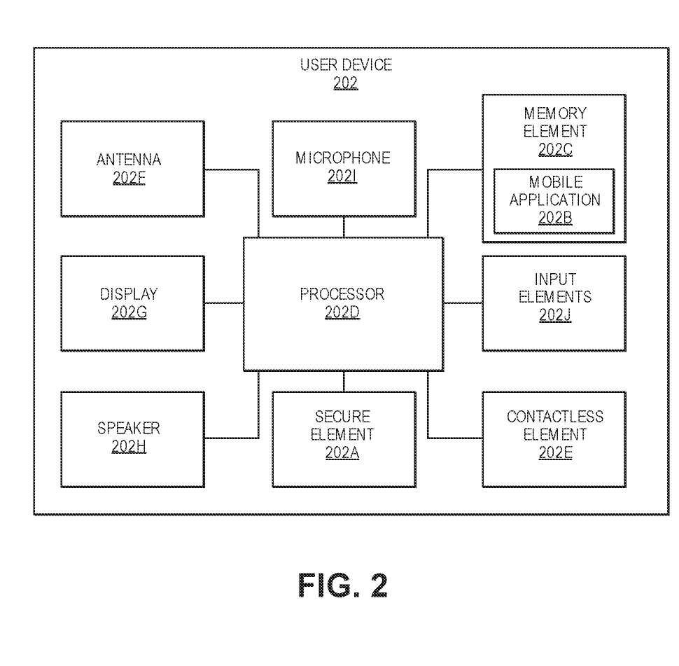

In some embodiments, user device 102 may include an application (e.g., payment application, wallet application, etc.) stored in a memory or secure element of mobile device 102. In some cases, the application may be a mobile application. In some embodiments, the application may be an interface on a website that allows the user to enter data for submission for processing a transaction. FIG. 2 describes various components of an exemplary user device in further detail.

Access device 104 may be any suitable device that provides access to a remote system. Access device 104 may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. Access device 104 may use any suitable contact or contactless mode of operation to send or receive data from, or associated with, user device 102.

In some embodiments, where access device 104 may comprise a POS terminal, any suitable POS terminal may be used and can include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “mPOS” terminal.

Access device 104 may also be used for communicating with other systems. For example, access device 104 may communicate with resource provider computer 106, transport computer 108, a processing network 110, authorization computer 112, or any other suitable system. Access device 104 may generally be located in any suitable location, such as at the location of a resource provider associated with resource provider computer 106. In some embodiments, access device 104 may receive data from a user device for a remote transaction (e.g., e-commerce transaction) and may forward the received data to an appropriate entity.

Resource provider computer 106 may be a device that is associated with a resource provider. The resource provider may engage in transactions, sell goods or services, or provide access to goods or services to the user associated with user device 102. Resource provider computer 106 may accept multiple forms of payment and may be associated with multiple tools to conduct different types of transactions. For example, resource provider computer 106 may be associated with access device 104 and communicate information to and from access device 104. In some cases, resource provider computer 106 may host a website associated with the resource provider through which the user may make a transaction. In some embodiments, resource provider computer 106 may also be able to request tokens associated with the user (e.g., payment tokens associated with user's payment credentials).

Transport computer 108 may be a device that may transmit information between entities. Transport computer 108 may be associated with resource provider computer 106, and may manage authorization requests on behalf of resource provider computer 106. Transport computer 108 may also handle token request messages on behalf of the resource provider computer 108. For example, in some embodiments, transport computer 108 may receive and forward token request messages in the same manner as authorization request messages. In some cases, transport computer 108 may be an acquirer computer associated with an acquirer.

The processing network 110 may include data processing subsystems, networks, and operations used to support and deliver authorization services, exception file services, and clearing and settlement services. For example, processing network 110 may comprise a server coupled to a network interface (e.g., by an external communication interface), and databases of information. In some cases, processing network 110 may be a transaction processing network (e.g., payment processing network). An exemplary processing network may include VisaNet™. Processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Processing network 110 may use any suitable wired or wireless network, including the Internet. In some embodiments, processing network 110 may be in communication with token vault 115.

Token vault 115 may comprise any information related to tokens. In some cases, token vault 115 may be one or more databases. For example, token vault 115 may store tokens and a mapping of the tokens to their associated accounts. Token vault 115 may comprise any sensitive information (e.g., account number) associated with tokens. In some embodiments, processing network 110 may communicate with token vault 115 to de-tokenize a token. Token vault 115 may de-tokenize the token by determining information associated with the token based on the stored mapping. In some embodiments, token vault 115 may reside at processing network 110.

Authorization computer 112 may be a device associated with an authorizing entity. Authorization computer 112 may authorize an entity to conduct a transaction or to receive access to goods or services on behalf of the authorizing entity. In some cases, authorization computer 112 may receive and process an authorization request message, as well as generate and transmit an authorization response message. In some embodiments, authorization computer 112 may be an issuer computer. The issuer computer is typically a computer run by a business entity (e.g., a bank) that may have issued the payment (credit/debit) card, account numbers or payment tokens used for the transactions. Some issuer systems can perform both issuer computer and acquirer computer functions. When a transaction involves a payment account associated with the issuer computer, the issuer computer may verify the account and respond with an authorization response message to the acquirer computer that may be forwarded to the corresponding access device, if applicable.

In some cases, at a later time (e.g., at the end of the day), a clearing and settlement process can occur between transport computer 108, processing network 110, and authorization computer 112.

Communications network 114 may be any suitable network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, and devices described herein may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

FIG. 2 depicts a block diagram of an exemplary user device 202. FIG. 2 shows a number of components, and user device 202 according to embodiments of the invention may comprise any suitable combination or subset of such components.

User device 202 may include a processor 202D (e.g., a microprocessor) for processing functions of user device 202. One exemplary function enabled by processor 202D includes processing functions of display 202G to allow a user to see information (e.g., interfaces, contact information, messages, etc.). Processor 202D may include hardware within user device 202 that can carry out instructions embodied as code in a computer-readable medium.

An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

User device 202 may comprise a secure element 202A. Secure element 202A may be a secure memory on user device 202 such that the data contained on secure element 202A cannot easily be hacked, cracked, or obtained by an unauthorized entity. Secure element 202A may be utilized by user device 202 to host and store data and applications that may require a high degree of security. Secure element 202A may be provided to user device 202 by a secure element issuer. Secure element 202A may be either embedded in the handset of user device 202 or in a subscriber identity module (SIM) card that may be removable from user device 202. Secure element 202A can also be included in an add-on device such as a micro-Secure Digital (micro-SD) card or other portable storage device.

Secure element 202A may store any suitable sensitive information. For example, secure element 202A may store financial information, bank account information, account (e.g., credit, debit, prepaid) number information, payment tokens associated with such account number information, account balance information, expiration dates, and verification values (e.g., CVVs, dCVVs, etc.). Other information that may be stored in secure element 202A may include user information or user data (e.g., name, date of birth, contact information, etc.). In other embodiments, some, none, or all of the foregoing information may be stored in memory element 102C or may be stored at a remote server computer (e.g., in the cloud).

User device 202 may comprise a memory element 202C (e.g., computer readable medium). Memory element 202C may be present within a body of user device 202 or may be detachable from the body of user device 202. The body of user device 202 may be in the form of a plastic substrate, housing, or other structure. Memory element 202C may store data (e.g., applications, etc.) and may be in any suitable form (e.g., a magnetic stripe, a memory chip, etc.).

Memory element 202C may comprise a mobile application 202B. Mobile application 202B may be computer code or other data stored on a computer readable medium (e.g. memory element 202C or secure element 202A) that may be executable by processor 202D to complete a task (e.g., provide a service). Mobile application 202B may be an application that operates on user device 202 and that may provide a user interface for user interaction (e.g., to enter and view information).

In some cases, mobile application 202B may be a payment application. Mobile application 202B may communicate with a wallet provider server computer to retrieve and return information during processing of any of a number of services offered to the user via user device 202 (e.g., provisioning accounts to a wallet application stored on user device 202).

User device 202 may further include a contactless element 202E, which may typically be implemented in the form of a semiconductor chip (or other data storage element) with an associated wireless transfer (e.g., data transmission) element, such as an antenna 202F. Contactless element 202E may be associated with (e.g., embedded within) user device 202. Data or control instructions transmitted via a cellular network may be applied to contactless element 202E by means of a contactless element interface (not shown). In some cases, the contactless element interface may function to permit the exchange of data and/or control instructions between the user device circuitry (and hence the cellular network) and an optional contactless element 202E.

Contactless element 202E may be capable of transferring and receiving data using a near-field communications (NFC) capability (or NFC medium) typically in accordance with a standardized protocol or data transfer mechanism (e.g., ISO 14443/NFC). User device 202 may support contactless transactions using the EMV contactless communication protocol (EMV-CCP), which is based on ISO 14443, in order to interact with access devices. This capability may typically be met by implementing NFC. The NFC capability of user device 202 may be enabled by an embedded NFC chip or by the addition of an external memory card or accessory that contains the NFC chip. NFC capability is a short-range communications capability, such as RFID, Bluetooth®, infra-red, or other data transfer capability that can be used to exchange data between the user device 202 and an interrogation device. Thus, user device 202 may be capable of communicating and transferring data and/or control instructions via both cellular network and near-field communications capability.

User device 202 may further include an antenna 202F for wireless data transfer (e.g., data transmission). Antenna 202F may be utilized by user device 202 to send and receive wireless communications. Antenna 202F may assist in connectivity to the Internet or other communications networks and enable data transfer functions. Antenna 202F may enable SMS, USSD, as well as other types of cellular communications, such as voice call and data communications.

User device 202 may include a display 202G that may show information to a user. Display 202G may be any suitable screen that enables touch functionality. In some embodiments, display 202G of user device 202 may display a user interface (e.g., of a mobile application or website) that may allow the user to select and interact with objects presented on display 202G. The objects may include, but may not be limited to, menus, text fields, icons, and keys/inputs on a virtual keyboard. In some embodiments, display 202G may enable a user to manually provide an electronic signature to user device 202 by directly touching display 202G with their finger or suitable touch screen stylus pen.

User device 202 may include a speaker 202H, which may be any suitable device that can produce sound in response to an electrical audio signal. Speaker 202H may play recorded sounds, as well as prerecorded messages to communicate with a user. In some cases, the user may be able to receive instructions by voice communications played by speaker 202H to which the user may respond (e.g., by returning voice command, activating input elements, etc.).

User device 202 may include a microphone 2021, which may be any suitable device that can convert sound to an electrical signal. Microphone 2021 may be utilized to capture one or more voice segments from a user. For example, microphone 2021 may allow the user to transmit his or her voice to user device 202. In some embodiments, the user may utilize voice commands detected by microphone 2021 to provide instructions to user device 202. In some cases, the user may provide voice commands detected by microphone 2021 to navigate through mobile application 202B.

User device 202 may further include input elements 202J to allow a user to input information into the device. Example input elements 202J include hardware and software buttons, audio detection devices (e.g., microphone), biometric readers, touch screens, and the like. A user may activate one or more of input elements 202J, which may pass user information to user device 202. In some cases, one or more of input elements 202J may be utilized to navigate through various screens of mobile application 202B.

In some embodiments, where user device 202 is a phone or other similar computing device, user device 202 may include a browser stored in the memory element 202C and may be configured to retrieve, present, and send data across a communications network (e.g., the Internet). In such embodiments, user device 202 may be configured to send data as part of a transaction. In some embodiments, user device 202 may provide the data upon request from another entity (e.g., access device).

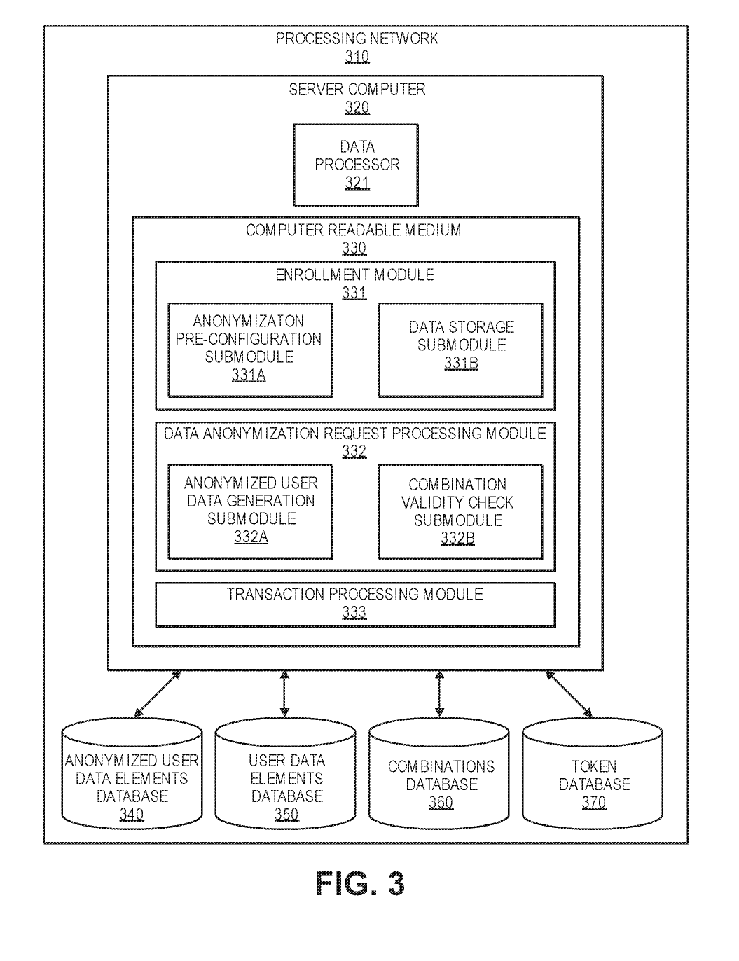

FIG. 3 shows a block diagram of some components that may be in an exemplary processing network 310 according to embodiments of the present invention. Processing network 310 includes a server computer 320 comprising a data processor 321 and a computer readable medium 330. The computer readable medium 330 may comprise a number of software modules including an enrollment module 331, a data anonymization request processing module 332, and a transaction processing module 333.

Other modules and submodules may also reside on the computer readable medium 330. Examples of additional modules may include an authorization module for processing and routing authorization request and response messages, a clearing and settlement module for processing and routing clearing messages and performing settlement between parties, and data extraction (e.g., for retrieving data from external data sources such as databases) modules, storage modules, and message modification modules. Each module in processing network 310 may be combined with any of the additional modules as appropriate. Each module in processing network 310 may comprise one or submodules, where each submodule may comprise one or more functions implemented by code, executable by data processor 321.

Processing network 310 may also comprise several databases, including an anonymized user data elements database 340, a user data elements database 350, a combinations database 360, and a token database 370. Each database may be a conventional, fault tolerant, relational, scalable, secure database such as those commercially available from Oracle™ or Sybase™. In some embodiments, any of the databases may be combined into a single database, or may be separated into multiple databases. Processing network 310 may have other databases that are not shown in FIG. 3.

Enrollment module 331 may enable, with data processor 321, processing user enrollment information. Enrollment information may also be referred to by any suitable name, such as registration data, registration information, and enrollment data. Enrollment module 331 may also include computer code for providing enrollment information to another entity, such as other modules in processing network 310, as appropriate. Enrollment module 331 may include an anonymization pre-configuration submodule 331A and a data storage submodule 331B.

Anonymization pre-configuration submodule 331A, in conjunction with data processor 321, may prompt a user for enrollment information and receive the enrollment information from a user device associated with a user over a suitable communications network. In some embodiments, the enrollment information may include anonymized user data elements entered by the user into their user device. For example, the user may be prompted, by any suitable user interface, to enter anonymized user data elements corresponding to user data elements (e.g., name, phone number, address, etc.) associated with their account. The user may then utilize their user device to enter the anonymized user data elements, which may be received by anonymization pre-configuration submodule 331A. Anonymization pre-configuration submodule 331A, with data processor 321, may then send the received anonymized user data elements, as well as a mapping of the anonymized user data elements and associated user data elements, to data storage submodule 331B.

In some embodiments, the enrollment information may also include a specific combination of user data elements selected by the user. For example, anonymization pre-configuration submodule 331A, in conjunction with the data processor 321, may prompt the user whether they would like to enroll a specific combination of user data elements to anonymize that can be applied for future transactions. The user may decide to enroll a specific combination of user data elements and enter a selection of user data elements to anonymize using any suitable user interface of their user device. In some embodiments, the user may also enroll a series of characteristics (e.g., period of validity, resource provider type restrictions, location restrictions, etc.) to be associated with the specific combination of user data elements. Anonymization pre-configuration submodule 331A, with data processor 321, may then send the received specific combination of user data elements and associated characteristics to data storage submodule 331B. In some cases, the user may enroll more than one specific combination of user data elements during one or more enrollment processes. Enrollment may be conducted at any time.

Data storage submodule 331B, in conjunction with data processor 321, may store enrollment information. Data storage submodule 331B may, with data processor 321, store some or all of the enrollment information received from anonymization pre-configuration submodule 331A in one or more of the databases of processing network 310. For example, data storage submodule 331B may, with data processor 321, store anonymized user data elements entered by the user, as well as the mapping of the anonymized user data elements and associated user data elements, in anonymized user data elements database 340. Additionally, data storage submodule 331B may, with data processor 321, store any specific combinations of user data elements selected by the user, as well as any characteristics associated with the specific combinations entered by the user, in combinations database 360. In some embodiments, data storage submodule 331B may also comprise computer code for managing integrity of enrollment information and update any newly received enrollment information as appropriate.

Data anonymization request processing module 332 may enable, in conjunction with data processor 321, handling of requests to anonymize user data for transactions. Data anonymization request processing module 332 may comprise computer code to generate, retrieve, store, and transmit data related to processing data anonymization requests. Data anonymization request processing module 332 may include an anonymized user data generation submodule 332A and a combination validity check submodule 332B.

Anonymized user data generation submodule 332A may, in conjunction with data processor 321, generate anonymized user data based on received data anonymization requests. In some embodiments, anonymized user data generation submodule 332A may comprise computer code to determine information included in a received data anonymization request and dynamically generate anonymized user data for a transaction conducted by a user. The information may include a specific combination of user data elements to be anonymized selected by the user, as well as other characteristics (e.g., restrictions) associated with the specific combination input by the user.

Anonymized user data generation submodule 332A may comprise computer code for retrieving data from the one or more databases of processing network 310 based on the selected specific combination of user data elements. For example, anonymized user data generation submodule 332A may, with data processor 321, retrieve one or more anonymized user data elements from anonymized user data elements database 340 that correspond to user data elements indicated in the specific combination of user data elements. Additionally, anonymized user data generation submodule 332A may, with data processor 321, retrieve any user data elements from user data elements database 350 that the user did not request to anonymize for the transaction. In some cases, anonymized user data generation submodule 332A also may, with data processor 321, retrieve a token (e.g., payment token) from token database 370. Anonymized user data generation submodule 332A may compile the retrieved data to generate anonymized user data for the transaction.

In some embodiments, the user may indicate characteristics to be associated with the specific combination of user data elements selected for the transaction. In some cases, the characteristics may include certain restrictions, such as the number of transactions for which the specific combination can be applied, validity period restrictions, resource provider type restrictions, location type restrictions, transaction amount (e.g., dollar value) restrictions, and the like.

Upon generating anonymized user data for the transaction, anonymized user data generation submodule 332A may, with data processor 321, store data, such as the anonymized user data for the specific combination and corresponding characteristics, if appropriate. For example, anonymized user data generation submodule 332A may comprise computer code to determine that data related to the specific combination does not have to be stored if the user indicates that the specific combination is for a one-time use. Additionally, anonymized user data generation submodule 332A may comprise computer code to determine that data related the specific combination may be stored if the user indicates that the specific combination is to be used multiple times. In some cases, the data may be stored in combinations database 360.

Combination validity check submodule 332B may, in conjunction with the data processor 321, determine whether a specific combination can be utilized for a transaction. In some embodiments, instead of configuring a specific combination of user data elements during a transaction, a user can select a specific combination of user data elements for which related data is already stored in combinations database 360. Combination validity check submodule 332B may comprise computer code for determining whether the specific combination of user data elements selected by the user is valid by checking the related data for any restrictions and applying the restrictions. If the specific combination of user data elements is valid based on the restrictions, combination validity check submodule 332B may, with data processor 321, determine that the specific combination of user data elements may be applied to the transaction. In one example, it may be determined that the specific combination of user data elements is associated with a resource provider type restriction, such that it may only be utilized at gas stations. If the transaction is being conducted at a gas station, the specific combination of user data elements may be deemed valid.

In some embodiments, combination validity check submodule 332B may comprise computer code for updating data in combinations database 360. This is because if a specific combination of user data elements is utilized for a transaction, certain characteristics associated with the specific combination of user data elements stored in combinations database 360 may become obsolete. For example, if the specific combination of user data elements is associated with a total number of transactions for which it may be utilized, combination validity check submodule 332B may, with data processor 321, decrease the remaining number of transactions for which the specific combination of user data elements may be utilized after a transaction is conducted. In some cases, combination validity check submodule 332B may comprise computer code for determining that a specific combination of user data elements is no longer valid (e.g., based on an associated expiration date) and delete data related to the specific combination of user data elements from combinations database 360.

Transaction processing module 333 may, in conjunction with data processor 321, enable any processing related to conducting a transaction. Transaction processing module 333 may enable receiving, processing, and sending authorization request messages and authorization response messages. In some cases, transaction processing module 333 may store any transaction data retrieved during transaction processing in one or more databases, some of which may not be shown in FIG. 3, of processing network 310.

Anonymized user data elements database 340 may store any information related to anonymized user data elements. In some embodiments, anonymized user data elements database 340 may comprise data related to multiple user accounts. In such cases, anonymized user data elements database 340 may store data organized by user account with each user account made differentiable by any suitable identifier (e.g., user account identifier). For each user account, anonymized user data elements database 340 may store anonymized user data elements configured by a user for their user account, as well as a mapping between the anonymized user data elements and corresponding user data elements.

User data elements database 350 may store any information related to user data elements. In some embodiments, user data elements database 350 may comprise data related to multiple user accounts. In such cases, user data elements database 350 may store data organized by user account with each user account made differentiable by any suitable identifier (e.g., user account identifier). For each user account, user data elements database 350 may store user data elements associated with the user account.

Combinations database 360 may store any information related to specific combinations of user data elements. In some embodiments, combinations database 360 may comprise data related to multiple user accounts. In such cases, combinations database 360 may store data organized by user account with each user account made differentiable by any suitable identifier (e.g., user account identifier). For each user account, combinations database 360 may store data related to one or more specific combinations of user data elements associated with the user account. In some embodiments, the data related to each specific combination of user data elements may include an a specific combination of user data elements, a unique identifier of the specific combination of user data elements, anonymized user data associated with the specific combination of user data elements, and any characteristics (e.g., restrictions) associated with the specific combination of user data elements. In some cases, the identifier may be text (e.g., “Combo 1”) input by the user. In other cases, the identifier may be any unique identifier generated by processing network 310.

Token database 370 may include any information related to tokens. For example, token database 370 may have similar features to those of token vault 115 described for FIG. 1. In some embodiments, token database 370 may comprise data related to multiple user accounts. In such cases, token database 370 may store data organized by user account with each user account made differentiable by any suitable identifier (e.g., user account identifier). For each user account, token database 370 may store tokens (e.g., payment tokens) and data related to the tokens associated with the user account.

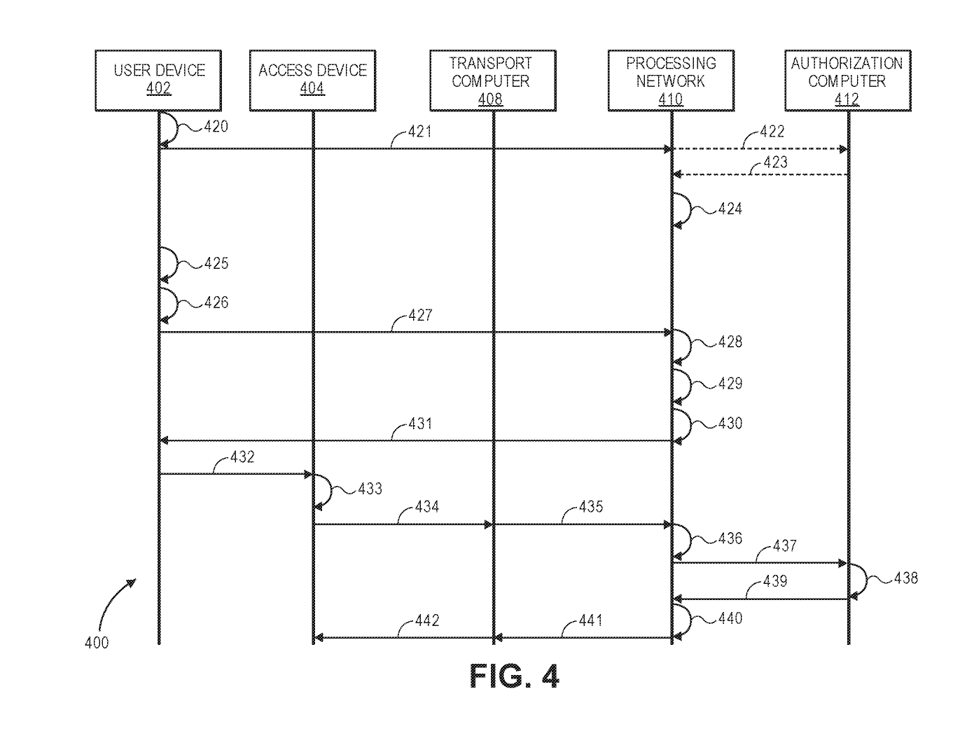

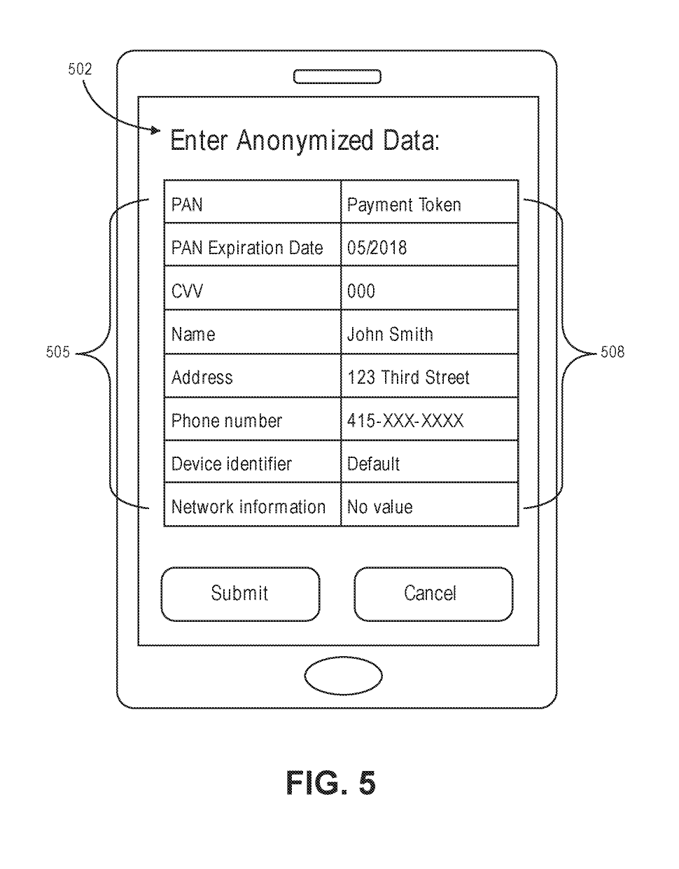

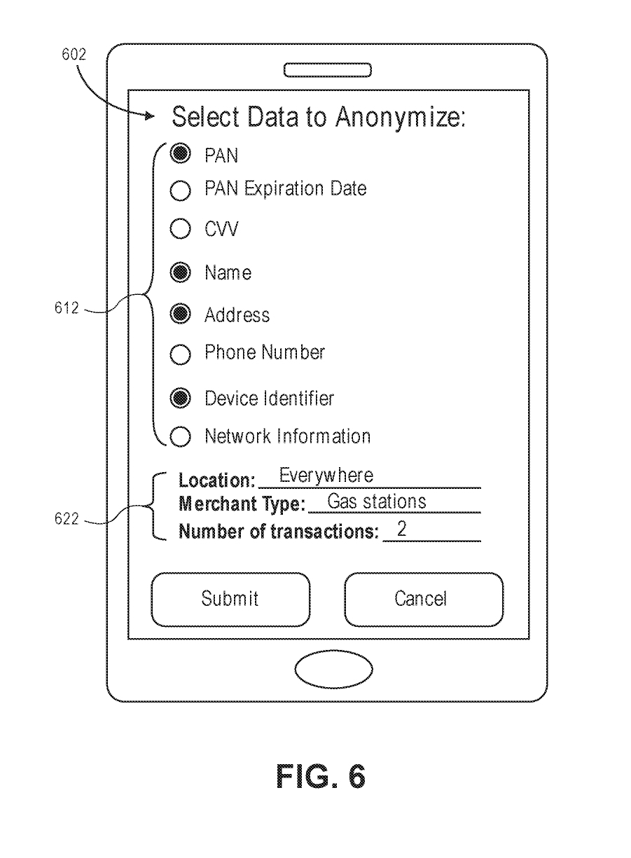

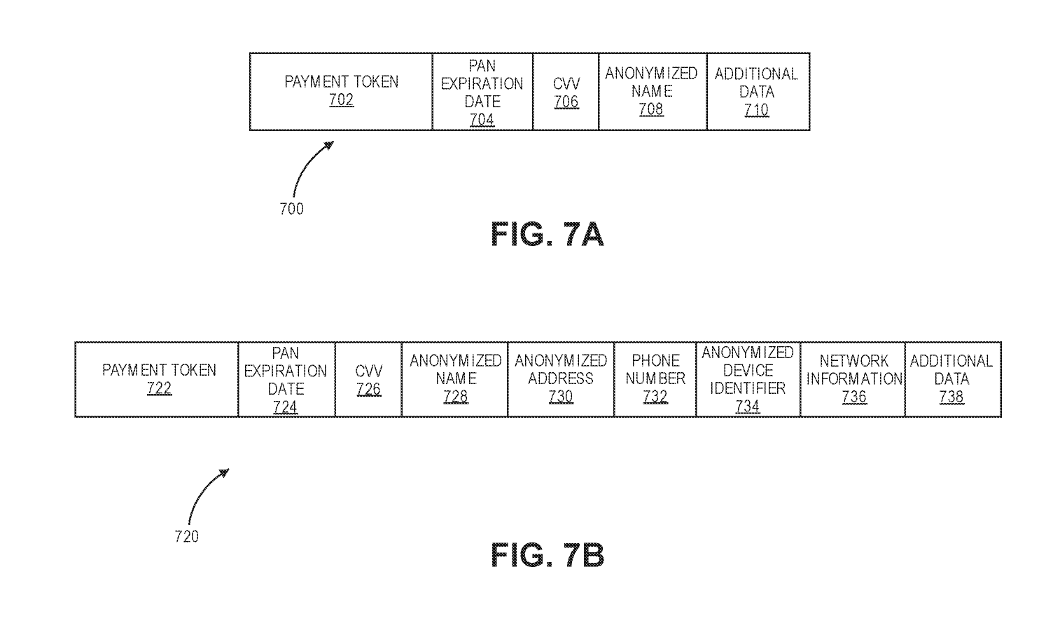

A method according to the embodiments of the invention can be described with respect to FIG. 4. FIG. 4 shows an exemplary flow diagram 400 of a method for processing a transaction with anonymized user data according to embodiments of the present invention. FIG. 4 includes a user device 402, an access device 404, a transport computer 406, a processing network 410, and an authorization computer 412. In some embodiments, transport computer 406 may be an acquirer computer, processing network 410 may be a payment processing network, and authorization computer 412 may be an issuer computer. The transaction may be conducted by a user associated with user device 402. Some steps in FIG. 4 may be described with respect to other figures, such as FIG. 5, FIG. 6, FIG. 7A, and FIG. 7B.

At step 420, user device 402 may receive anonymized user data elements entered by the user after the user initiates an enrollment process. The enrollment process may be conducted prior to a transaction and may comprise the user pre-configuring anonymized user data elements to be utilized to anonymize their user data. The user may enter anonymized user data elements for any user data element associated with their account. In some embodiments, the user may additionally create a PIN or password during the enrollment process that can be utilized to protect use of their anonymized user data.

Each anonymized user data elements may be associated with each corresponding user data element. Exemplary types of user data elements include name, address, phone number, device information (e.g., device identifier), network information (e.g., MAC address, Bluetooth® information), account identifier (e.g., personal account number (PAN)), account identifier expiration date, and card verification value (CVV). In some embodiments, the user data elements described herein may be associated with subgroups (e.g., Bluetooth® information may be a subgroup of network information) and thus may be split into multiple user data elements. In some cases, anonymized user data elements may comprise aliases (e.g., fake data) entered by the user. In some cases, anonymized user data elements may comprise other placeholders, such as no data (e.g., null value), randomized values, a combination (e.g., concatenation) of various known information, or default values. After the user enters enrollment information including anonymized user data elements, the user may confirm transmission of the entered enrollment information by any suitable method (e.g., pressing software button). The user may enter anonymized user data elements by interacting with any suitable interface. An exemplary user interface is shown in FIG. 5.

FIG. 5 shows an exemplary user interface 502 for inputting anonymized user data elements according to embodiments of the present invention. FIG. 5 includes a user device that may be operated by a user and that can display user interface 502 of a mobile application. User interface 502 may comprise user data element types 505 and anonymized user data elements 508. While user interface 502 depicts one user interface according to embodiments of the invention, any other suitable user interface may be utilized.

User data element types 505 may comprise types of user data elements that may be utilized for transactions conducted by the user. For example, user data element types 505 may include PAN, PAN expiration date, CVV, name, address, phone number, device identifier, and network information (e.g., Bluetooth® information). Any group of suitable user data element types, including those not shown in FIG. 5, may be included in user data element types 505. Based on the presented user data element types 505, the user may determine for which user data elements to generate anonymized user data elements.

Anonymized user data elements 508 may comprise data input by the user corresponding to user data element types 505. The data may be utilized to anonymize user data elements, which may be associated with the user's account, corresponding to user data element types 505. In some embodiments, anonymized user data elements 508 may be entered using editable text fields in user interface 502.

As shown in FIG. 5, anonymized user data elements 508 may be in various forms. In the illustrated example, the user may indicate that anonymized user data elements for the PAN may be a payment token associated with the user's account. Additionally, the user may enter the anonymized user data element for the PAN expiration date, CVV, name, address, and phone number comprising anonymized user data element values, “05/2018, “000,” “John Smith,” “123 Third Street,” and “415-XXX-XXXX,” respectively. Further, the user may indicate that the anonymized user data element for the device identifier may be a default value configured by the mobile application and that the anonymized user data element for the network information may be no value. The user may confirm transmission of anonymized user data elements 508 by pressing a software button, such as the “Submit” button shown in user interface 502.

Referring back to FIG. 4, at step 421, user device 402 may send a communication comprising the anonymized user data elements and related information to processing network 410. The anonymized user data elements and related information may be sent over any suitable communications network. In some embodiments, the anonymized user data elements may be sent with a mapping of associations with corresponding user data elements. Steps 422 and 423 shown in FIG. 4 may be optional steps.

In some embodiments, as shown in steps 422 and 423, processing network 410 may request and receive data from authorization computer 412. For example, processing network 410 may request and receive one or more user data elements associated with the user's account that may be stored by authorization computer 412. In some embodiments, processing network 410 may already store the one or more user data elements and hence not request user data from authorization computer 412.

At step 424, processing network 410 may store the anonymized user data elements in association with corresponding user data elements. In some embodiments, the anonymized user data elements may be stored along with information related to bindings between the user data elements and the anonymized user data elements. This ensures that processing network 410 can manage sensitive information, while the user does not need to remember all private binding when utilizing the anonymized user data elements in future transactions.

In some implementations, the anonymized user data elements and bindings may be provisioned onto user device 402. These anonymized user data elements and bindings may be accessible by an application (e.g., mobile application) run on user device 402 during a transaction.

At step 425, user device 402 may receive a request to initiate a transaction. In some cases, the user may launch an application and interact with the user interface of the application to request initiation of the transaction. In some embodiments, the mobile application may be a mobile wallet application (e.g., payment application) capable of communicating with entities over a communication network and conducting a transaction according to embodiments of the present invention. The mobile wallet application may communicate with an API service (e.g., of processing network 410). In some embodiments, the mobile wallet application may have a web user interface.

The mobile application may present the user with the option to conduct the transaction as a transaction with anonymized user data or as a regular transaction. The user may utilize the user interface of the mobile application to indicate that they would like to conduct the transaction with anonymized user data. If the user wants to conduct a regular transaction, the transaction may be processed as a typical transaction without utilization of anonymized user data. However, in some cases, the user may want to conduct a transaction with anonymized user data.

For a transaction utilizing anonymized user data, the mobile application may provide the user with various options. For example, the user may choose to utilize anonymized user data associated with a previously configured specific combination of user data elements or select a new specific combination of user data elements at the time of purchase. If the user selects to utilize previously configured specific combination of user data elements, the mobile application may access the anonymized user data previously provisioned on the mobile device. If the user decides to utilize a new specific combination of user data elements, a suitable user interface may be presented to the user. An exemplary user interface is shown in FIG. 6.

FIG. 6 shows an exemplary user interface 602 according to embodiments of the present invention. FIG. 6 includes a user device that may be operated by a user and that can display user interface 602 of a mobile application. User interface 602 may comprise user data element types 612 and restrictions 622. While user interface 602 depicts one user interface according to embodiments of the invention, any other suitable user interface may be utilized. Using a user interface like the one shown in FIG. 6, a user may select arbitrary combinations of data elements to anonymize.

User data element types 612 may comprise types of user data elements that may be utilized for transactions conducted by the user. For example, user data element types 612 may include a PAN, PAN expiration date, CVV, name, address, phone number, device identifier, and network information (e.g., Bluetooth® information). Any group of suitable user data element types, including those not shown in FIG. 6, may be included in user data element types 612. Based on the presented user data element types 612, the user may determine for which user data elements to anonymize for a transaction.

As shown in FIG. 6, the user may utilize user interface 602 to make one or more selections from user data element types 612. In the illustrated example, the user may select the PAN, name, address, and device information as the user data elements to anonymize for a transaction. This selection may indicate a specific combination of user data elements selected by the user, where the specific combination of user data elements may designate the selected user data elements to be anonymized and other user data elements to be utilized with their real values.

The user may also utilize user interface 602 to designate restrictions 622 associated with the selected specific combination of user data elements. In some embodiments, restrictions 622 may include a location restriction, merchant type restriction, and a transaction count restriction. A merchant may be type of resource provider. In the illustrated example, the user may indicate that the specific combination of user data elements may be utilized “Everywhere,” meaning no location restrictions may be enforced. Additionally, the user may place a restriction for use to the merchant type, “Gas stations,” meaning that the specific combination of user data elements may only be utilized at gas stations. It may be the case that the user prefers not to have their identity exposed to merchants associated with gas stations. Further, the user may indicate a restriction for transaction count to two transactions, meaning that the specific combination of user data elements may only be utilized two times. Any group of suitable restriction types, including those not shown in FIG. 6 (e.g., transaction amount, time period of validity, etc.), may be included in restrictions 622.

The user may confirm transmission of the selected combination of user data elements from user data element types 612 and restrictions 622 by pressing a software button, such as the “Submit” button shown in user interface 602. Subsequently, for the example depicted in FIG. 6, the PAN, name, address, and device information associated with the user's account may be anonymized for a future transaction conducted by the user and this selected combination of user data elements may only be utilized for two transactions at gas stations residing in any locations.

Referring back to FIG. 4, at step 426, user device 402 may process the received request to initiate a transaction and may generate an anonymization request. The anonymization request may be generated based on information in the received request. The anonymization request may include information input by the user using the mobile application, such as the specific combination of user data elements to be anonymized for the transaction, along with certain characteristics (e.g., restrictions) related to the specific combination of user data elements.

At step 427, user device 402 may send the anonymization request to processing network 410. The anonymization request, which may be in the form of a message, may be sent over any suitable communications network, may request generation of anonymized user data. In some embodiments, the mobile application on user device 402 may call an API service associated with processing network 410 in order to generate the anonymized user data.

While FIG. 4 show steps 428 through 430 being conducted by processing network 410, embodiments are not so limited. For example, in some embodiments, steps 428 through 430 can be performed by another entity, such as user device 402, without communicating with processing network 410. This may be possible if data utilized to generate anonymized user data is provisioned to user device 402. Accordingly, in such cases, steps 427 and 431 comprising transmission of the anonymization request and anonymized user data may not be performed as shown. In some embodiments, user device 402 may send the anonymized user data to processing network 410 after generating the anonymized user data.

At step 428, processing network 410 may determine the specific combination of user data elements selected by the user based on the received anonymization request. For example, based on the examples illustrated in FIG. 5 and FIG. 6, processing network 410 may determine that the user requests the PAN, name, address, and device information associated with the user account to be anonymized.

At step 429, processing network 410 may retrieve anonymized user data elements indicated in the specific combination of user data elements. Processing network 410 may access one or more databases to retrieve the anonymized user data elements. In some embodiments, processing network 410 may retrieve the anonymized user data elements corresponding to the user data elements to be anonymized indicated in the specific combination of user data elements, where the anonymized user data elements may be stored in association with their corresponding user data elements. In other embodiments, processing network 410 may retrieve the anonymized user data elements based on stored bindings associating the anonymized user data elements and corresponding user data elements.

At step 430, processing network 410 may generate anonymized user data for the transaction. The anonymized user data may be generated in real time during the transaction. In some cases, the user may know of the anonymized data prior to making the request (e.g., if the user supplied examples of anonymized data to use). In other cases, the processing network 410 may generate the anonymized data specifically for the current transaction or for the specific user. For example, based on the examples illustrated in FIG. 5 and FIG. 6, the PAN may be substituted by a payment token, the name by a substitute name, “John Smith,” the address by a substitute address, “123 Third Street,” and the device identifier by a default value (e.g., concatenation of various information, such as the location of token consumption, dollar amount limit, and domain (e.g., merchant binding)) configured by the mobile application. Other user data elements that the user did not select to anonymize, such as PAN expiration date, CVV, phone number, and network information, may be retrieved to be utilized with their real values.

At step 431, processing network 410 may send the anonymized user data to user device 402, and some or all of the anonymized user data may be transmitted to the access device 404 from the user device 402. The anonymized user data may be sent over any suitable communications network. In some embodiments, the anonymized user data may be provisioned onto user device 402 so that it can be accessed by the mobile application running on user device 402 for a future transaction. In other embodiments, the processing network 410 may send the anonymized user data directly to the access device 404.

At step 432, user device 402 may send the anonymized user data to access device 404. The anonymized user data may be sent in any suitable manner. In some embodiments, access device 404 may be associated with a resource provider (e.g., merchant), which may operate a resource provider computer. In one example, the transaction may be an in-person transaction conducted between the user and the resource provider. In this case, user device 402 may transmit the anonymized user data to access device 404 by contactless NFC, by scanning the display of user device 404, or by another suitable method. In another example, the transaction may be a remote transaction (e.g., e-commerce transaction) conducted between the user and the resource provider. In this case, user device 402 may send the anonymized user data to access device 404 over any suitable communications network.

At step 433, access device 404 may generate an authorization request message for the transaction. In some embodiments, the authorization request message may include an indicator that the transaction is being conducted with anonymized user data. The indication may be in any suitable form, such as an identifier or flag. In some embodiments, the indicator may not be included in the anonymization request, but instead may be sent with the authorization request message.

In some embodiments, the authorization request message may comprise some or all of the anonymized user data. In the cases in which all the anonymized user data is included in the authorization request message, all the user data elements selected by the user to be anonymized indicated in the specific combination of user data elements may be replaced with corresponding anonymized user data elements in the authorization request message. In the cases, in which some of the anonymized user data is included in the authorization request message, one or more anonymized user data elements in the anonymized user data may replace corresponding user data elements in the authorization request message as appropriate. Following the examples illustrated in FIG. 5 and FIG. 6, exemplary authorization request messages are depicted in FIGS. 7A and 7B.

FIG. 7A shows an exemplary authorization request message 700 according to embodiments of the present invention. Authorization request message 700 may include a portion of anonymized user data generated for the transaction. For example, authorization request message 700 may include a payment token 702 and anonymized name 708 in the authorization request message 700. Payment token 702 may be a payment token associated with the user's account and anonymized name 708 may be “John Smith” as depicted in FIG. 5. Other information in the authorization request message may not be anonymized, such as PAN expiration date 704 and CVV 706.

Further, in some embodiments, authorization request message 700 may include additional data 710. Additional data 710 may be any information that may be utilized by entities when processing authorization request message 700. For example, additional data 710 may comprise a token requestor ID, POS entry mode, token cryptogram, a dollar amount value of the transaction, and other information. In some cases, the resource provider computer associated with access device 404 may define the dollar amount value associated with the transaction and then include the dollar amount value in authorization request message 700 as part of additional data 710. Any of additional data 710 may provide processing network 410 and authorization computer 412 with additional information that can be utilized for fraud models, which may limit risk.

FIG. 7B shows an exemplary authorization request message 720 according to embodiments of the present invention. As shown, in some embodiments, all of anonymized user data for a transaction may be included in the authorization request message. For example, authorization request message 720 may include anonymized user data elements for user data elements selected by the user using user interface 602 in FIG. 6. The anonymized user data elements may include a payment token 722 (e.g., payment token associated with user's account), an anonymized name 728 (e.g., “John Smith”), an anonymized address 730 (e.g., “123 Third Street), and an anonymized device identifier 734 (e.g., Default value determined by processing network). Other user data elements may not be anonymized based on the user selection, such as a PAN expiration date 724, a CVV 726, a phone number 732, and network information 736. In some cases, authorization request message 720 may include additional data 738, which may be similar to additional data 710 described in FIG. 7A.

Referring back to FIG. 4, steps 434 and 435 may comprise the transmission of the authorization request message. At step 434, access device 404 may send the authorization request message to transport computer 408. At step 435, transport computer 408 may then send the authorization request message to processing network 410. The authorization request message may be sent over any suitable communications network. In some embodiments, transport computer 408 may further add information to the authorization request message that may be useful for entities conducting the authorization process. As shown, any user data the user may desire to anonymize may not be sent to access device 404 and transport computer 408, which reduces risk of user identity and information being comprised.

At step 436, processing network 410 may process the authorization request message. In some embodiments, processing network 410 may recognize that the transaction is being conducted with anonymized user data based an indicator (e.g., identifier, flag, etc.) included in or sent with the authorization request message that the transaction is being conducted with anonymized user data. In some embodiments, the indicator may indicate for which user data elements the data is anonymized so that processing network 410 may differentiate between real and anonymized values. Processing network 410 may retrieve corresponding user data elements as necessary during the transaction. In some embodiments, the user data elements for which the data is anonymized may be the user data elements indicated in the specific combination of user data elements selected by the user.

In some embodiments, processing network 410 may determine that the transaction is being conducted with anonymized user data without an indicator included in or sent with the authorization request message. Based on processing in steps 428 and 429, processing network 410 may recognize the anonymized user data elements corresponding to the specific combination of user data elements selected by the user for the transaction. If any of these anonymized user data elements are included in the authorization request message, processing network 410 may determine that the transaction is being conducted with anonymized user data and may proceed to retrieve real data to conduct further processing. For example, the user may select an anonymized account number corresponding to a payment token, an anonymized name corresponding to “John Smith”, an anonymized address corresponding to “123 Third Street), and an anonymized device identifier corresponding to a default value for the transaction, as shown in FIG. 5 and FIG. 6. If processing network 410 receives an authorization request message including the above anonymized user data elements, then it may determine that that these anonymized user data elements are anonymized data and proceed to retrieve real user data elements.

In some embodiments, processing network 410 may update the authorization request message by adding information in authorization request message that may help authorization computer 412 authorize the transaction. In some cases, this additional information may help identify the user account of the user to authorization computer 412 and enable authorization computer 412 to apply relevant fraud models to securely process the transaction.

In some embodiments, processing network 410 may include information in the authorization request message regarding validity of the specific combination of user data elements being utilized for the transaction. For example, processing network 410 may determine whether any restrictions associated with the specific combination user data elements are broken based on condition surrounding the transaction. Processing network 410 may include the result of the determination in the authorization request message. In some embodiments, processing network 410 may further conduct other fraud analyses. This information from processing network 410 may serve to notify authorization computer 412 of information regarding the validity of the transaction.

In some cases, processing network 410 may update the authorization request message to include user data elements instead of anonymized user data elements. For example, processing network 410 may include a PAN associated with the payment token included in the authorization request message. Processing network 410 may retrieve the PAN from any suitable database, such as a token database or a token vault, by de-tokenizing the payment token. This PAN may enable authorization computer 412 to identify the account with which the transaction is being conducted. In some cases, other anonymized user data elements may be replaced with real values (e.g., user name, device identifier, etc.) to help authorization computer 412 identify the user or account associated with the transaction for fraud analyses purposes. In some embodiments, processing network 410 may include any fraud information associated with the user's account in the authorization request message.

At step 437, processing network 410 may send the authorization request message to authorization computer 412. The authorization request message may be sent over any suitable communications network. In some embodiments, authorization computer 412 may conduct fraud analyses upon receiving the authorization request message. For example, if the PAN is included in the authorization request message, authorization computer 412 may identify the user's account associated with the PAN being utilized for the transaction and determine fraud information related to the account. Authorization computer 412 may check if any information related to fraud is already stored in account data associated with the account. Additionally, authorization computer 412 may apply fraud models based on historical information related to the account and information related to the transaction being conducted to determine additional potential fraud information. In some cases, the fraud analyses may comprise deriving a token assurance level, which may help determine whether the transaction is secure and should be completed.

At step 438, authorization computer 412 may determine whether the transaction can be authorized and generate an authorization response message. In some cases, authorization computer 412 may determine whether the transaction is authorized based on fraud information included in the authorization request message or derived based on information included in the authorization request message. In some embodiments, the authorization response message may include the result of the authorization determination, the token assurance level, and user data elements associated with the user's account included in the authorization request message (e.g., PAN, user name, etc.). Privacy of the user's data may be maintained since the authorization response message may comprise anonymized user data elements corresponding to certain user data elements requested by the user to be anonymized.

In some embodiments, processing network 410 may not translate all anonymized user data elements to real user data elements in step 436. In this case, the authorization request message may include one or more anonymized user data elements, which may be received by authorization computer 412. In some cases, authorization computer 412 may include the received one or more anonymized user data elements in the authorization request message.

At step 439, authorization computer 412 may send the authorization response message to processing network 410. The authorization response message may be sent over any suitable communications network.

At step 440 processing network 410 may process the authorization response message. Processing network 410 may determine whether authorization computer 412 authorized the transaction based on the authorization response message. In some embodiments, if the authorization response message includes the payment token, processing network 410 may de-tokenize the payment token to retrieve the PAN and associate the authorization decision of the transaction to the PAN. The PAN may identify the user's account to be utilized for the transaction. Other user data elements in the authorization response message may also be associated with the authorization decision of the transaction. The authorization decision and related information may be stored by processing network 410 for future transaction processing (e.g., fraud processing).

In some embodiments, processing network 410 may substitute the user data elements for anonymized user data elements in the authorization response message. For example, processing network 410 may substitute the PAN with the payment token in the authorization response message, so that the PAN may not be exposed to other entities. Similarly, other user data elements may be translated to their corresponding anonymized user data elements stored by processing network 410. This may ensure that sensitive data is not processed by other entities (e.g., resource provider computer) and thus reduce the risk of stolen.

Steps 441 and 442 may comprise transmission of the authorization response message. At step 441, processing network 410 may send the authorization response message to transport computer 408. At step 442, transport computer 408 may send the authorization response message to access device 404. The authorization response message may be transmitted over any suitable communications network.

In some embodiments, access device 404 or the resource provider computer associated with access device 404 may determine whether to authorize completion of the transaction. For example, the determination may be made based on the token assurance level included in the authorization response message. If the token assurance level is determined to be at an acceptable level, the transaction can be completed. Accordingly, the user may be authorized to conduct the transaction and the user may receive goods or services associated with the transaction.

In some embodiments, the resource provider computer associated with access device 404 may store the authorization response message. In some cases, authorization response messages or the data in them may be stored to keep track of transactions conducted with the resource provider associated with the resource provider computer. Since the authorization response message may include anonymized user data utilized in the transaction instead of real user data, this reduces the risk of sensitive data being compromised at the resource provider computer. In some embodiments, the resource provider computer may store the anonymized user data at another step, such as at step 433. Even if data stored by the resource provider computer is subject to a hacking attack, the anonymized user data would not reveal any real information about the user. Thus, embodiments of the invention enable better data security than conventional transaction processing systems and methods.

In some implementations, the user may be notified of the completion of the transaction. For example, access device 404 may show a notification on its display to the user that the transaction has been completed. In some cases, a notification indicating the completion of the transaction may be sent to the mobile application on user device 402. The notification may be presented to the user in any suitable manner.

In some cases, at a later time (e.g., at the end of the day), a clearing and settlement process can occur between transport computer 408, processing network 410, and authorization computer 412.

Although the use of a token assurance level is described in this example, it and even a payment token are not required in embodiments of the invention.

Embodiments of the invention may provide a number of advantages. For example, a resource provider (e.g., merchant) will not know the identity of the user at any point in the transaction. Accordingly, it is not possible for the resource provider to associate a particular user to their user data and the resource provider will not be capable of mining sensitive information related to the user. This can prevent the resource provider from tracking recent or past visits, product browsing history, purchase history, location information, and other information related to the user. Embodiments of the invention ensure that the user is provided with desired privacy of sensitive information, while still enabling secure transaction processing (e.g., with fraud analyses).

Embodiments of the invention further provide privacy options that are configurable to a specific transaction. While the user may pre-configure anonymized user data by selecting a specific combination of user data elements to anonymize during enrollment, the user may also request to dynamically select a specific combination of user data elements and dynamically generate anonymized user data in real time. Since the user can select a specific combination of user data elements to be anonymized at the time of the transaction, privacy options are flexible and customizable. This is advantageous as the user may conduct various types of transactions that may call for different privacy levels. To accommodate, the user may limit use of anonymized user data to certain transaction (e.g., associated with specific location, region, merchant types, transaction amount, etc.).

Additionally, embodiments of the present invention may provide a more secure offering of a prepaid card. Typically, prepaid card use is plagued with fraud, money laundering, and other criminal activities. This can arise when another payment instrument, such as a credit card, is utilized to load funds onto prepaid cards. The risk lies in the fact that the user associated with the payment instrument is anonymous to the authorization computer (e.g., issuer) and the processing network (e.g., payment processing network). Since anonymized user data may be bound to the user and the payment instrument, embodiments of the present invention may enable the authorization computer and processing network to conduct fraud mitigation processes. Thus, services utilizing anonymized user data may be beneficial to entities that utilize prepaid cards.

Further, authorization computers (e.g., issuers) often combine several types of prepaid programs under one bank identification number (BIN), which makes monitoring of a portfolio for unusual behavior difficult. This can be due to different card types have varying characteristics, such as average loads, transaction sizes, and merchant activity. Proper segmenting of card numbers can be achieved by utilizing anonymized user data, as an authorization computer can control the format of the anonymized user data issued and generated.

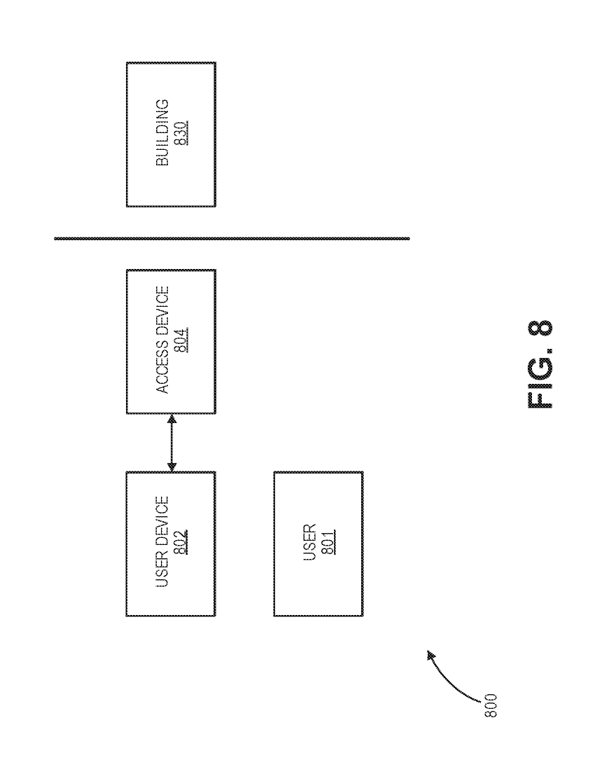

While embodiments related to financial contexts are described above, embodiments are not so limited. For example, embodiments of the invention may be applicable in other non-financial contexts that involve access to a resource or service based on providing sensitive information. FIG. 8 depicts an exemplary case.

FIG. 8 shows an exemplary block diagram of an access system. FIG. 8 shows a user device 802 operated by a user 801, an access device 804, and a building 830. The user device 802 has been provisioned with anonymized user data as described above. The user device 802 can interact with the access device 804 and pass the anonymized user data to access device 804. The access device 804 may locally verify the received anonymized user data or it may communicate with a remotely located authentication server computer (not shown) with which the user previously enrolled (See below for more details). The remotely located authentication server computer may verify that the anonymized user data is authentic and may transmit a signal indicating successful verification back to access device 804. The access device 804 may then proceed to let the user 206 enter the building 830.

In some embodiments, the anonymized user data may include any information that can be utilized to identify user 801. Typical building access protocols may involve a user providing a physical identification card (e.g., driver's license), which may potentially expose sensitive information, such as their full name, date of birth, and address, to others. Embodiments of the invention enable user 801 to be identified as a person authorized to access the building without exposing this sensitive user data.

In some embodiments, providing the anonymized user data may provide access to a service associated with building 830. For example, after providing the anonymized user data that is then verified as valid, user 801 may be authorized to complete a check-in process for a subsequent appointment (e.g., doctor's appointment) at building 830. Typical check-in protocols may require a user to fill out user information on physical forms, as well as provide physical identification cards. This risks exposure of the user's sensitive information to others.

Instead, embodiments of the invention enable user 801 to provide the anonymized user data from user device 802 to access device 804 without exposing such sensitive information. The user device 802 can interact with the access device 804 and pass the anonymized user data to access device 804. In some cases, user device 802 may be running a mobile application associated with the service associated with building 830. In some embodiments, the passed information may be displayed by access device 804.

However, even if access device 804 presents information received from user device 802, no sensitive information may be displayed. For example, the screen of access device 804 may show an electronic version of a typical check-in form comprising text fields (e.g., name, phone number). After receiving the anonymized user data, access device 804 may pre-populate the text fields with anonymized user data elements included in the anonymized user data. Subsequently, the user may edit any information or add any missing fields (e.g., description of purpose of appointment) as desired by interacting with access device 804. Any other party that sees the screen of access device 804 or duplication of the displayed information may not be able to obtain the user's sensitive data. User 801 may confirm transmission of the anonymized user data from access device 804. If user 801 is successfully verified, the check-in process may be completed.

In some embodiments, the verification process may be conducted by a remote authentication server computer. The remote authentication server computer may be associated with the entity utilizing access device 804. Access device 804 may send the anonymized user data to the authentication server computer upon user 801 confirming transmission of the anonymized user data. In some embodiments, the anonymized user data may be sent with an identifier, which may be any unique combination of characters and may be stored in association with the user's enrollment data stored by the remote authentication server computer. This identifier may show that the authentication server computer that the information receives includes anonymized user data. Based on the user identifier, the remote authentication server computer may be able to retrieve the user's real user data corresponding to the anonymized user data elements. The remote authentication server computer may then run an identity verification check base on the user's real user data before the user may be allowed access to building 830 or the service associated with building 830. Accordingly, no real user data can be accessed by access device 804 and other entities (e.g., doorman, receptionist, etc.), while still allowing the user to be verified.

In some embodiments, the authentication server computer may recognize, without receiving the identifier, that the information received includes anonymized user data. For example, the authentication server computer may receive and recognize a specific set of anonymized user data elements from access device 804. If these particular anonymized user data elements were selected for use by the user during a prior enrollment process, the authentication server computer may recognize that the received information includes anonymized user data and then retrieve the corresponding user data elements for verification.

Additional methods and processes may be included within the above methods and may be recognized by one of ordinary skill in the art, in light of the description herein. Further, in some embodiments of the present invention, the described methods herein may be combined, mixed, and matched, as one of ordinary skill would recognize.

A computer system may be utilized to implement any of the entities or components described above. Subsystems of the computer system may be interconnected via a system bus. Additional subsystems may include a printer, a keyboard, a fixed disk (or other memory comprising computer readable media), a monitor, which is coupled to a display adapter, and others. Peripherals and input/output (I/O) devices, which couple to an I/O controller (which can be a processor or other suitable controller), can be connected to the computer system by any number of means known in the art, such as by a serial port. For example, the serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a user device or different device associated with a user, anonymized user data elements corresponding to user data elements associated with an account of the user;
transmitting, by the user device or the different device, the anonymized user data elements to a server computer;
receiving, by the user device, a request to conduct a transaction with anonymized user data associated with the account, the request including a specific combination of user data elements selected by the user;
generating, by the user device, a request to anonymize at least one user data element indicated in the specific combination;
receiving, by the user device, the anonymized user data including at least one anonymized user data element associated with the at least one user data element indicated in the specific combination; and
transmitting, by the user device, the anonymized user data to an access device.

2. The method of claim 1, further comprising:
transmitting, by the user device, the request to anonymize the at least one user data element to the server computer, and wherein the server computer generates the anonymized user data.

3. The method of claim 1, wherein the access device generates and sends an authorization request message including the anonymized user data to the server computer.

4. The method of claim 1, wherein the user data elements in the specific combination of user data elements are associated with a location, type of resource provider, or transaction amount.

5. The method of claim 4, wherein the specific combination of user data elements is associated with a number of transactions for which it can be utilized selected by the user.

6. The method of claim 1, wherein the user selects the specific combination of user data elements at the time of the transaction.

7. The method of claim 1, further comprising:
storing, by the user device, a binding between the anonymized user data elements and the user data elements associated with the account of the user.

8. The method of claim 7, further comprising:
generating, by the user device, the anonymizer user data; and
storing the anonymized user data at the user device.

9. The method of claim 1, wherein the server computer stores bindings between the anonymized user data elements and the user data elements associated with the account of the user.

10. The method of claim 9, wherein the server computer generates the anonymized user data and sends the anonymized user data to the user device.

11. A user device comprising:
a processor; and
a computer-readable medium coupled to the processor, the computer-readable medium comprising code, executable by the processor, for performing a method comprising:
receiving, by the user device or a different device associated with a user, anonymized user data elements corresponding to user data elements associated with an account of the user;
transmitting, by the user device, the anonymized user data elements to a server computer;
receiving, by the user device, a request to conduct a transaction with anonymized user data associated with the account, the request including a specific combination of user data elements selected by the user;
generating, by the user device, a request to anonymize at least one user data element indicated in the specific combination;
receiving, by the user device, the anonymized user data including at least one anonymized user data element associated with the at least one user data element indicated in the specific combination; and
transmitting, by the user device, the anonymized user data to an access device.

12. The user device of claim 11, the method further comprising:
transmitting, by the user device, the request to anonymize the at least one user data element to the server computer, and wherein the server computer generates the anonymized user data.

13. The user device of claim 11, wherein the access device generates and sends an authorization request message including the anonymized user data to the server computer.

14. The user device of claim 11, wherein the user data elements in the specific combination of user data elements are associated with a location, type of resource provider, or transaction amount.

15. The user device of claim 14, wherein the specific combination of user data elements is associated with a number of transactions for which it can be utilized selected by the user.

16. The user device of claim 11, wherein the user dynamically selects the specific combination of user data elements at the time of the transaction.

17. The user device of claim 11, the method further comprising:
storing, by the user device, a binding between the anonymized user data elements and the user data elements associated with the account of the user.

18. The user device of claim 17, the method further comprising:
generating, by the user device, the anonymizer user data; and
storing the anonymized user data at the user device.

19. A method comprising:
receiving, by a server computer from a user device or different device associated with a user, anonymized user data elements corresponding to user data elements associated with an account of the user;
storing, by the server computer, the anonymized user data elements in association with the corresponding user data elements;
receiving, by the server computer, a request including a specific combination of user data elements selected by the user for a transaction to anonymize at least one user data element indicated in the specific combination of user data elements;
determining, by the server computer, the specific combination of user data elements from the request;
retrieving, by the server computer, anonymized user data elements associated with the at least one user data element indicated in the specific combination of user data elements;
generating, by the server computer, anonymized user data including the anonymized user data elements for the transaction; and
sending, by the server computer, the anonymized user data to the user device associated with the user, wherein the user device sends the anonymized user data to an access device.

20. A server computer comprising:
a processor; and
a computer-readable medium coupled to the processor, the computer-readable medium comprising code, executable by the processor, for performing a method comprising:
receiving, by a server computer from a user device or different device associated with a user, anonymized user data elements corresponding to user data elements associated with an account of the user;
storing, by the server computer, the anonymized user data elements in association with the corresponding user data elements;
receiving, by the server computer, a request including a specific combination of user data elements selected by the user for a transaction to anonymize at least one user data element indicated in the specific combination of user data elements;
determining, by the server computer, the specific combination of user data elements from the request;
retrieving, by the server computer, anonymized user data elements associated with the at least one user data element indicated in the specific combination of user data elements;
generating, by the server computer, anonymized user data including the anonymized user data elements for the transaction; and
sending, by the server computer, the anonymized user data to the user device associated with the user, wherein the user device sends the anonymized user data to an access device.
